(19) United States
(12) Patent Application Publication
(10) Pub. No.: US 2026/0141298 A1
(43) Pub. Date: May 21, 2026

(54) ENHANCED INFORMATION PROCESSING

(71) Applicant: Arm Limited, Cambridge (GB)

(72) Inventors: Maxim Novikov, Cambridge (GB); Ignazio Indovina, Cambridge (GB)

(73) Assignee: Arm Limited, Cambridge (GB)

(21) Appl. No.: 19/309,012

(22) Filed: Aug. 25, 2025

(30) Foreign Application Priority Data
Aug. 30, 2024 (GB) 2412747.4

(51) Int. Cl. G06N 20/00; G06N 5/04

(52) U.S. Cl. CPC G06N 20/00; G06N 5/04

(57) ABSTRACT

A method performed by an information processing apparatus is provided. The method may comprise obtaining input data, determining a parameter value of an input data parameter associated with the input data, and configuring a machine learning model to the parameter value, comprising determining a set of inference model parameters associated with the determined parameter value by performing either of: (i) interpolating model parameter values from two or more sets of model parameters to obtain the set of inference model parameters, each set being associated with a respective reference value of the input data parameter, or (ii) applying a second machine learning model to the parameter value to obtain the inference model parameters. The method may further comprise processing the input data using the configured machine learning model to generate output data associated with the parameter value comprising applying the inference model parameters to the input data.

### CROSS-REFERENCE TO RELATED APPLICATION

This application claims the benefit under 35 U.S.C. § 119(a) and 37 CFR § 1.55 to United Kingdom patent application no. 2412747.4, filed on Aug. 30, 2024, the entire content of which is incorporated herein by reference.

### TECHNICAL FIELD

The present disclosure relates to methods performed by an information processing apparatus, a computer-implemented method for training a machine learning model to process data, a data processing system and a computer program product. The disclosure has particular relevance to image processing including, but not limited to, applications such as removal of noise from images.

### BACKGROUND

Information processing devices, such as servers, computers, mobile phones, IoT devices etc., are used for processing a wide range of information including textual, audio, image and video data. Processing of textual data may find application in some settings such as language processing and synthetic text generation. Media data processing may find application in a variety of settings, such as home monitoring, industrial security, graphics processing and gaming applications. In particular, media processing may include operations, such as noise removal and anti-aliasing. Additionally, information processing devices may perform follow-up actions based on the results of media processing, such as image classification. For example, processed video data may be further classified for providing user alerts in security applications. Many application settings may require the capability of on-the-fly processing.

Requirements of inexpensive information processing devices with on-board media processing capacity capabilities may place constraints on the size and complexity of the machine learning model employed. Methods described herein address these and other related challenges.

### SUMMARY

According to a first aspect of the present invention, there is provided a method performed by an information processing apparatus. The method may comprise obtaining input data, determining a parameter value of an input data parameter associated with the input data, and configuring a machine learning model to the parameter value, comprising determining a set of inference model parameters associated with the determined parameter value by performing either of: (i) interpolating model parameter values from two or more sets of model parameters to obtain the set of inference model parameters, each set of the two or more sets of model parameters being associated with a respective reference value of the input data parameter, or (ii) applying a second machine learning model to the parameter value to obtain the inference model parameters. The method may also comprise processing the input data using the configured machine learning model to generate output data associated with the parameter value comprising applying the inference model parameters to the input data.

By configuring the machine learning model to obtain a set of inference model parameters associated with a parameter value, the information processing apparatus may be adapted to generate output data associated with the parameter value. As a result, the information processing apparatus may account for variations of the input data with values of the associated input data parameter. In particular, parametric variations may be captured by the method without relying on large or complex machine learning models that are trained on big datasets including statistically significant sample data associated with parametric variations. In this manner, the resource requirements of the information processing apparatus are reduced whilst allowing a significant degree of configurability to parametric dependencies in the input data.

The machine learning model may further comprise multiple sets of model parameters including a first set of model parameters associated with a first reference value of the input data parameter and a second set of model parameters associated with a second reference value of the input data parameter. In such examples, the set of inference model parameters may be determined by interpolating model parameter values from the first set of model parameters and the second set of model parameters.

By determining the set of inference model parameters based on interpolating model parameter values from the first and second set of model parameters, a machine learning model with a significantly lower complexity and memory requirement can be on-boarded on the information processing apparatus. In this manner, the sets of model parameters may be interpolated during operation of the information processing apparatus; further, the interpolations may be performed without excessive computational burden.

Interpolating the first set of model parameters and the second set of model parameters may comprise determining interpolation functions based on the first set of model parameters, the first reference value, the second set of model parameters, and the second reference value. The set of inference model parameters may be determined by evaluating the interpolation functions at the determined parameter value.

By determining interpolation functions for interpolating the sets of model parameter values, the process of configuring the machine learning model may be made straightforward and more adaptable to a range of settings. For example, interpolating the multiple sets of model parameters can be performed in a computationally efficient manner by making use of off-the-shelf computational libraries.

The machine learning model may further include multiple sets of model parameters including an intermediate set of model parameters associated with an intermediate reference value of the input data parameter. The intermediate reference value may lie between the first reference value and the second reference value of the input data parameter. Determining the set of inference model parameters may comprise interpolating model parameter values from the intermediate set of model parameters to determine the set of interpolated weights associated with the parameter value.

In this manner, higher order interpolation may be performed between two or more sets of model parameters included in the machine learning model. Various combinations of linear and non-linear interpolation approaches may be adopted in dependence on the accuracy requirements for a given use case.

The method may include obtaining the input data parameter as a first input data parameter and the parameter value may be a first parameter value, and the method may further comprise determining a second parameter value for a second input data parameter associated with the input data. The multiple sets of model parameters may further include a third set of model parameters and a fourth set of model parameters. The first set of model parameters, second set of model parameters, third set of model parameters, and fourth set of model parameters each may be associated with respective values of the first input data parameter and the second input data parameter. Configuring the machine learning model may further comprise interpolating model parameters values from the third set of model parameters and the fourth set of model parameters to determine the set of interpolated model parameters.

By addressing the variation of the sets of model parameters with two or more input data parameters, the machine learning model may be configured to process input data associated with variations dependent on multiple parameters.

According to further aspects, there are provided computer-implemented methods for training a machine learning model. The machine learning model may comprise multiple sets of model parameters including a first set of training model parameters associated with a first reference value of an input data parameter and a second set of training model parameters associated with a second reference value of the input data parameter. The method may comprise obtaining a set of training data and carrying out one or more iterations comprising selecting, from the set of training data, sample data associated with a sample parameter value. The iterations may further comprise determining a set of sample model parameters associated with the sample parameter value by interpolating model parameter values from the first set of training model parameters and the second set of training model parameter, and estimating a cost in dependence on sample outputs generated by applying the set of sample model parameters to the sample data. The iterations may also comprise updating the multiple sets of model parameters in dependence on the estimated cost.

Interpolating the first set of training model parameters and the second set of training model parameters as part of the method may comprise determining an interpolation function for each model parameter based on the corresponding model parameter in the first set of training model parameters, the first reference value, the corresponding model parameter in the second set of training model parameters, and the second reference value. The sample model parameter may be determined by evaluating the interpolation function at the sample parameter value.

The method may comprise calculating one or more interpolation coefficients that distribute the cost between the first set of training model parameters and second set of training model parameters. Updating the multiple sets of training model parameters may comprise estimating an adjustment for the sample model parameters in dependence on the cost, and updating the first set of training model parameters and the second set of training model parameters in dependence on the adjustment and the one or more interpolation coefficients.

Using interpolation coefficients, the backpropagation stage during training of the machine learning model may be extended to the multiple sets of machine learning model parameters. The multiple sets of model parameters included in the machine learning model are thereby updated in accordance with the effectiveness of the interpolation to generate accurate output data. In this manner, the machine learning model is trained to be configurable during the inference stage.

The method may comprise training the machine learning model using supervised learning. Each sample data from the training dataset may have a respective ground truth data associated with the parameter value, and estimating the cost may comprise applying a cost function comparing the training output and the sample output. The method may also comprise training the machine learning model using alternative approaches. Training may be conducted using reinforcement learning or unsupervised learning in which no ground truth data may be available.

According to a further aspect of the present invention, there is provided a method performed by an information processing apparatus. The method may comprise obtaining input image data, determining a parameter value of an input data parameter associated with the input image data, and configuring a machine learning model to the parameter value, comprising determining a set of inference model parameters associated with the determined parameter value by performing either of: (i) interpolating model parameter values from two or more sets of model parameters to obtain the set of inference model parameters, each set of the two or more sets of model parameters being associated with a respective reference value of the input data parameter, or (ii) applying a second machine learning model to the parameter value to obtain the inference model parameters. The method may also comprise processing the input image data using the configured machine learning model to generate output image data associated with the parameter value comprising applying the inference model parameters to the input data.

By configuring the machine learning model to obtain a set of inference model parameters associated with a parameter value, the processor may be adapted to generate output image data associated with the parameter value. Processing the input image data using the configured machine learning model may involve removing noise from the input image data. The noise may be associated with a sensor measurement or a gain level. The output image data generated as a result of such processing may be associated with a reduced level of noise. The input data device may be at least one of a camera, an image signal processor, or another device that can provide stored or received input image data.

According to further aspects, a method of training a second machine learning model to determine a set of inference model parameters based on a plurality of input data parameters may be provided. The method may comprise obtaining sample data that is associated with a plurality of input data parameters. A set of inference model parameters may be determined based on the plurality of input data parameters. The generated set of inference model parameter values may be applied to the input data to generate sample output data associated with the plurality of sets of parameter values for each of the plurality of parameters. A cost may be estimated for the sample output data generated. The cost may be back propagated to generate an updated set of inference model parameter values. Training the second machine learning model may involve generating a cost based on the updated set of inference model parameter values and updating a set of model parameters included in the second machine learning model in dependence on the cost estimated.

Using a second machine learning model, a mapping between the parameter values associated with the input data and the inference set of model parameters may be approximated. By thereby training the second machine learning model to generate the inference set of model parameters, the resource requirements associated with storing multiple sets of model parameters as part of the machine learning model may be significantly reduced. As a result, a higher operating efficiency of the information processing apparatus for media processing may be achieved.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic of an information processing apparatus for media processing;

FIG. 2 shows an example machine learning model architecture employed by the information processing apparatus for media processing;

FIG. 3 is a schematic illustrating a method performed by the information processing apparatus for media processing;

FIG. 4A shows an illustrative example of linear interpolation;

FIG. 4B shows an illustrative example of non-linear interpolation;

FIG. 5 shows an illustrative example of bilinear interpolation;

FIG. 6 is a flow diagram of the method performed by the information processing apparatus for media processing;

FIG. 7 is a schematic of a method performed for training the machine learning model included in the information processing apparatus; and FIG. 8 is a flow diagram of the method performed for training the machine learning model included in the information processing apparatus.

### DETAILED DESCRIPTION

### Preliminaries

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to media processing by an information processing apparatus using a machine learning model. The embodiments relate to processing media data using a machine learning model that accounts for values of input data parameters, such as lighting conditions or noise levels, linked with the media data. In particular, the methods described herein address challenges such as increased model size and complexity arising from adapting machine learning models to account for the input data parameter in addition to the media data.

To address these challenges, some disclosed embodiments make use of interpolation between multiple sets of machine learning model parameters each corresponding to respective reference values of the input data parameter. For a given media data file with a corresponding input data parameter value, the multiple sets of model parameters can be interpolated to the given parameter value, which may be thereafter used for processing the media file. In this manner, the embodiments disclosed alleviate the need for a relatively more complex machine learning model that ingests input data parameters as additional inputs provided alongside the input media data.

The embodiments disclosed further include methods of training the machine learning model involving interpolation of the multiple sets of model parameters during a forward pass stage and a distribution of costs from a cost function among the multiple sets of model parameters during a backward propagation stage.

Several approaches to training a machine learning model to handle a variable parameter exist. A simple case would be to include the parameter as an input to the machine learning model. Another naïve approach to generating machine learning models to handle different parameter values would be to separately train a plurality of machine learning models for particular parameter values, each machine learning model being trained using data sampled at the particular parameter value. The predictions from the models could be interpolated between the parameter values associated with the machine learning models. However, it should be noted that interpolating between trained sets of model parameters from these trained machine learning models (rather than interpolating their predictions) is ordinarily expected to lead to nonsensical outputs even though each set of model parameters may individually generate sensical outputs. Methods disclosed herein overcome this difficulty by incorporating the interpolation between sets of model parameters during the training procedure. Moreover, a relatively small number of sets of model parameters may be sufficient for accounting for variations across a range of parameter values, thereby reducing the overall size and complexity of the machine learning model. Subsequently, the overall media processing time may be reduced, resulting in a more efficient information processing apparatus.

### Description of Information Processing Device

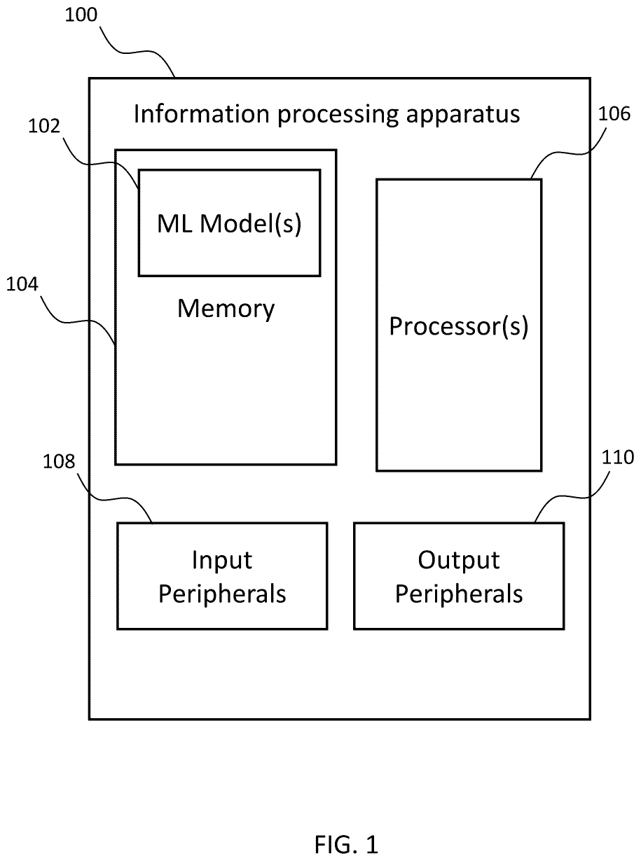

FIG. 1 is a schematic diagram of an information process apparatus 100 for media processing. The apparatus 100 comprises a trained machine learning model 102 stored in a memory 104, one or more processor 106, input peripherals 108, and output peripherals 110.

In the illustrated example, the machine learning model 102 is stored in a storage in the form of memory 104. In other examples, the model 102 may be present in the form of dedicated hardware that emulates the trained machine learning model 102. In general, more than one machine learning model 102 may be used. The memory 104 may include components such as RAM, DRAM, SSD, etc. In some examples, the processor(s) 106 may be microprocessors included together with memory 104 components on a single integrated circuit. In other examples, the processor(s) 106 may include CPUs or GPUs.

The information processing apparatus may take many forms. In some examples, the information processing apparatus may be a server, distributed hardware for a cloud service, a computer, a mobile device such as a laptop or mobile phone, an IoT device etc. In one particular example, the information processing apparatus may be an image signal processor (ISP).

The information processing apparatus 100 in FIG. 1 further comprises input peripherals 108, which may include devices such as microphones, video cameras or other media capture devices. The input peripherals 108 may further include keyboards, mice and/or tactile inputs such as touch screens or touch pads. The input peripherals may include sensors such as optical, vibration or thermal sensors. For instance, optical sensors may quantify and lighting conditions in the form of luminance or colour and provide as inputs to the peripherals 108.

The apparatus 100 further comprises output peripherals 110 that may include display components such as LCD screens for displaying output data. In some examples, the output peripherals 110 may connect to external devices that may further process the processed output data provided by the information processing apparatus 100. For instance, external devices may display the processed data or perform actions in response to identifying occurrences or events within the processed data.

Various methods will be described below. Any of these methods may be implemented by one or more computer programs that may be stored on a non-transitory computer-readable storage medium and run on one or more information processing apparatus. In some implementations, the source code for any such program may be written in Python, C, C++, Rust, Julia, etc and may use specific development frameworks, libraries, or packages, including PyTorch, TensorFlow, Keras, CUDA, etc. The examples provided herein for the hardware and software components do not constitute an exhaustive list; many more similar components may be alternatively or additionally included.

### Machine Learning Model Architecture

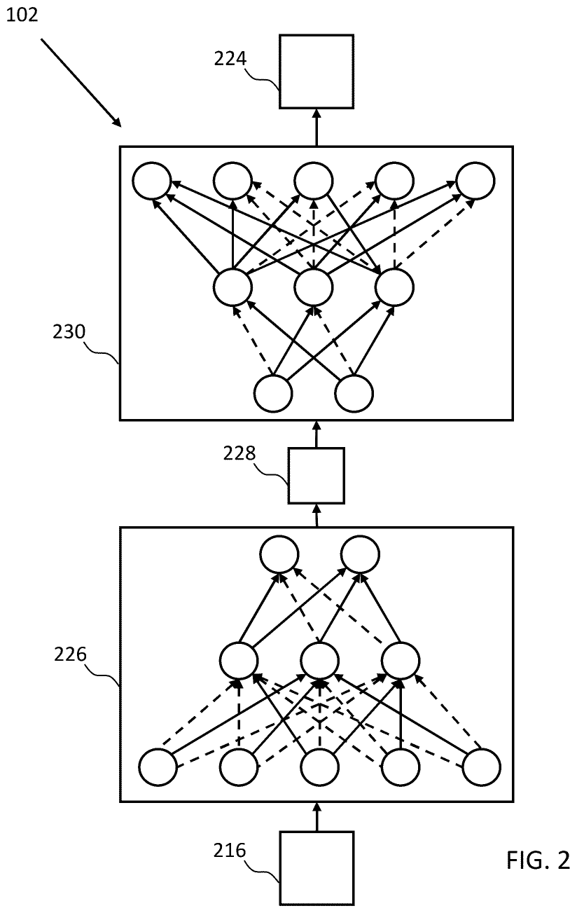

FIG. 2 shows an example machine learning model architecture of the machine learning model 102. As will be explained in greater detail below, the machine learning model 102 may comprise two or more sets of model parameters. FIG. 2 shows a single set of the parameters for ease of illustration.

In the example shown, the architecture corresponds to an encoder-decoder architecture employing a Convolutional Neural Network (CNN). The encoder portion 226 comprises a neural network with CNN architecture comprising layers with decreasing numbers of nodes. Each node may be associated with a model parameter in the form of a bias term. Moreover, the nodes from a preceding layer may be connected with nodes in a succeeding layer using edges. Each edge may be associated with a model parameter in the form of a weight. Values of the weights may correspond to real numbers. The edges depicted using solid lines may be associated with non-zero weight values. The edges depicted using dashed lines may be associated with zero weight values. The weights and biases may be combined using an activation function at each node in a given layer to generate numerical values which are subsequently processed by a subsequent layer.

The encoder portion 226 may process input data 216 using the first layer and extract features in the input data 216 in subsequent layers. Upon processing the input data 216, the encoder portion 226 may generate a hidden state 228. The decoder portion 230 may similarly comprise a neural network that processes the hidden state 228 and generates output data 224 corresponding to the input data 216 over a series of successive layers with increasing number of nodes.

The set of inference model parameters may include different values of weights and biases for the edges and nodes of the neural network included in the decoder portion 230 compared with those for the edges and nodes of the neural network included in the encoder portion 226. For different configurations of the machine learning model, the set of inference model parameters may include different values of edge weights and node biases for the neural network in the encoder or decoder portions. For example, the set of weights and biases may vary with the parameter value associated with the input data 216.

The machine learning model may comprise two or more sets of weight values. Each set of weight values is associated with a particular (reference) parameter value. The architecture of the neural networks included in the encoder and decoder portions may be maintained for each set of weight values i.e. regardless of the parameter value associated with the set of weights. In this manner, the set of inference model parameters may be tasked to perform the same processing action for input data 216 corresponding to different parameter values. Further, there is a one-to-one correspondence between the parameters, such as weights and biases, between each set of model parameters.

As will be explained further below, in other implementations, the machine learning model 102 may be configured using a second machine learning model to generate a set of inference model parameters 222.

### Inference Using a Machine Learning Model—Interpolation

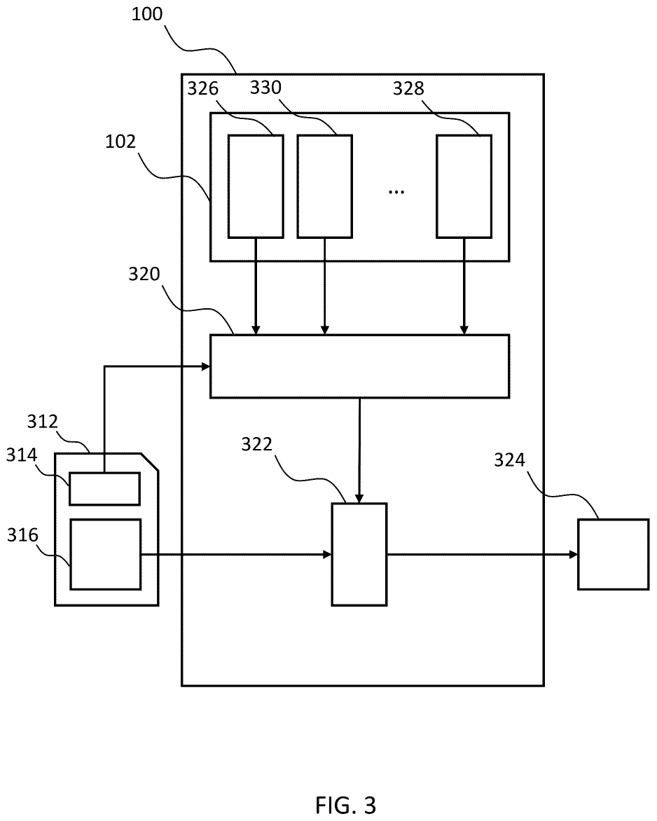

FIG. 3 is a schematic diagram illustrating a method performed by the information processing apparatus 100 for media processing. In overview, input data 312 is obtained by the information processing apparatus 100. The input data 312 includes image data 316 (in other implementations the input data may include other types of data as well as or instead of the image data) along with associated parameter data 314. The machine learning model 102 comprises multiple sets of model parameters 326, 328, and 330. A configuration module is configured to determine a set of inference model parameters 322 for processing the image data 316 based on the parameter data 314 and the sets of model parameters, 326, 328, and 330. The input image data 316 is then processed using the inference model parameters 322 by performing inference based on the model architecture described above in connection with FIG. 2 to generate output data 324. These steps will now be described in more detail.

In some examples, the input data 312 may be obtained by the information processing apparatus 100 using the input peripherals 108. For example, input peripherals 108 may comprise an image capture device, such as a camera, and an input data parameter may represent a gain used by a camera sensor when capturing the image data 316. In some examples, the input data parameter may be associated with a noise level associated with the image data. In such examples, the processing performed by the machine learning model 102 may be configured to remove noise from the image data 316.

In further examples, the input data parameter may designate a lighting condition such as luminance or illuminance associated with the capture of the image data 316. In such cases, for example the illuminance value may be obtained from a sensor to characterise the illuminance of an image included in the image data 316.

Further, the parameter data 314 including the input data parameter may be obtained from metadata generated at the time of capture of the image data 316 and stored with the image data. Metadata for the image data 316 may either be obtained as part of the image data 316 or may be provided separately from the input data 312. The metadata may designate a measurable characteristic of the image, the conditions in which the image was captured, or device settings used to capture the image.

A parameter value is determined that is either equal to a value of the input data parameter in the parameter data or a value derived therefrom.

After obtaining the parameter data 314 and image data 316 associated with input data 312, the method proceeds by configuring the machine learning model 102 included in the information processing apparatus 100 to the parameter value identified from the parameter data 314.

In this example, the machine learning model 102 comprises multiple sets of model parameters 326, 328, 330 and so on. As explained above, each of the model parameters may correspond to trainable parameters such as weights and biases of a neural network. Each set of model parameters may be associated with the same architecture of the neural network. In this example, an encoder-decoder architecture is used, but the model parameters may also correspond to trainable parameters of other types of machine learning models. Regardless of the precise setting to which the model parameters correspond, the machine learning model 102 may comprise two or more sets of model parameters. Each set of model parameters may correspond to a prescribed respective reference value of the input data parameter for which the parameter value associated with the image data 316 was previously determined.

The configuration module 320 may configure the machine learning model 102 to the parameter value of the input data 312 by interpolating the model parameter values from the two or more sets of model parameters to obtain inference model parameters 322 associated with the parameter value. For example, the two or more sets of model parameters may each be associated with different reference values of a gain used to capture the image data 316. The sets of model parameters may be interpolated to a given parameter value associated with the image data 316 to obtain inference model parameters 322. In particular, each inference model parameter is obtained by interpolation between the values of the corresponding model parameter in each of the sets of model parameters being interpolated.

Although FIG. 3 explicitly shows three sets of model parameters 326, 328 and 330, the machine learning model 102 may in general include an arbitrary number of sets of model parameters each associated with a respective value of the input data parameter. By increasing the number of sets of model parameters in the machine learning model 102 for a given range of parameter reference values, the information processing apparatus 100 may be able to increase the accuracy of the interpolation in that range. Moreover, the sets of model parameters may not correspond to respective reference parameter values that are equally spaced. For instance, the machine learning model 102 may include a higher number of model parameter sets within a given range of parameter values where a higher accuracy of interpolation is desired. As the number of sets of model parameters increases, however, the resource requirements of the machine learning model 102 are expected to increase. Thus, in either example described above, the machine learning model 102 is configured to map the parameter value to a set of inference model parameters 322, which can be used for processing the image data 316 associated with the parameter value and thereby generate output data 324 associated with the parameter value.

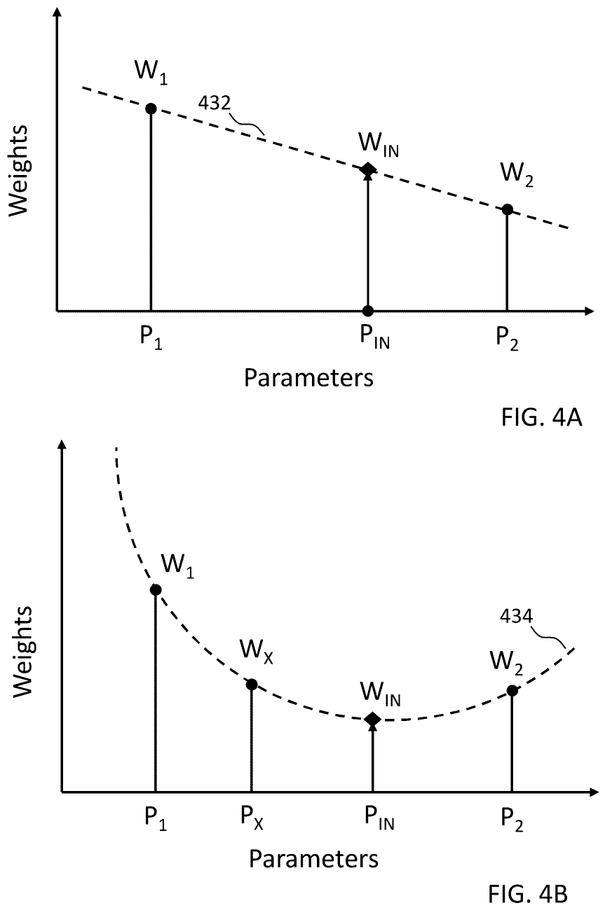

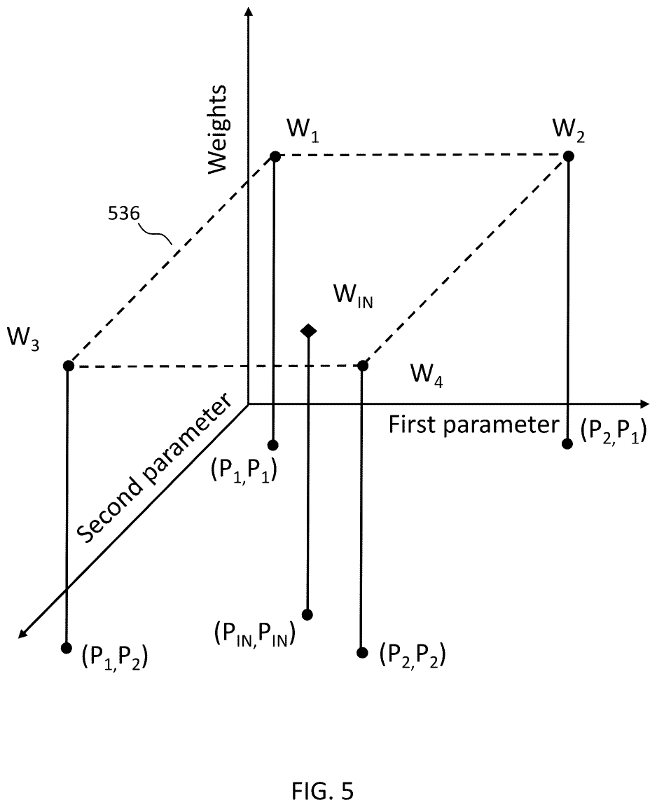

FIG. 4A shows an illustrative example of linear interpolation. In particular, FIG. 4A illustrates linear interpolation of weight values for a given edge between two nodes of the neural network for a machine learning model 102 including two sets of model parameters. The variable W₁ designates the value of the model parameter (in this example, the weight) in the first set of model parameters 326, and the variable P₁ designates the respective first reference value of the input data parameter. Likewise, the variable W₂ designates the value of the model parameter (in this example, the weight) in the second set of model parameters 328, and the variable P₂ designates the respective second reference value of the input data parameter.

In some settings, the first and second reference values may correspond to limiting values (i.e. extreme values) of the input data parameter. For example, the first reference value may correspond to a gain value of 0% and the second reference value may correspond to a gain value of 100%. In the example shown in FIG. 4A, the parameter value P_{IN} is associated with given image data 316 and apparently lies within the interval of values enclosed by the first and second reference values P₁ and P₂. Configuring of the machine learning model 102 by the configuration module 320 involves interpolating the model parameter value W₁ and W₂ from their respective parameter values P₁ and P₂ to the parameter value P_{IN}.

In the “weight”-“parameter” plane, this corresponds to interpolating the points (P₁, W₁) and (P₂,W₂) to a point with the parameter value P_{IN} in order to determine the corresponding weight value WIN. For example, given the pair of points on the plane, it is mathematically possible to determine a linear interpolation function 432, such as the polynomial w=a₀+a₁p wherein w represents the model parameter for an arbitrary parameter value p. The coefficients a₀ and a₁ may be determined by solving a pair of simultaneous equations obtained by substituting the points (P₁,W₁) and (P₂,W₂) into the polynomial equation w=a₀+a₁p. In this manner, the equation for the linear interpolation function 432 may be determined.

The approach suggested is but one of a variety of alternative mathematical approaches that can be adopted to determine a linear interpolation function. In particular, various computational algorithms may be employed that determine the interpolation function efficiently. Furthermore, in some cases, the equation for the linear interpolation function 432 determined may not be satisfied exactly for the sets of model parameter values due to introduction of further corrections in the interpolation function 432 to suit the needs of any given application.

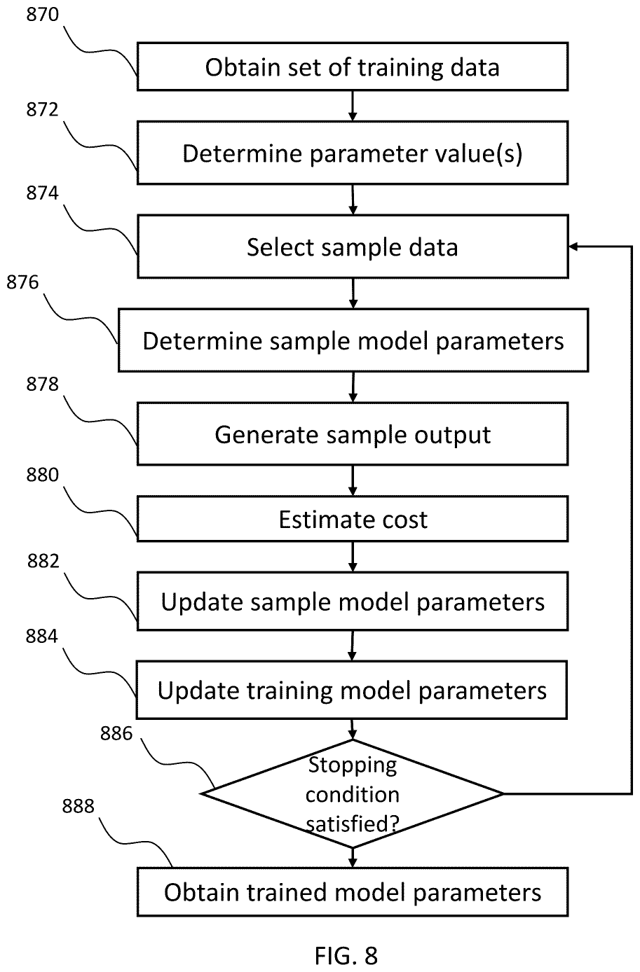

Once a linear interpolation function 432 is determined, the configuration module 320 may apply the function to the parameter value P_{IN} to obtain the corresponding weight value W_{IN}. The coefficients of the linear interpolation function 432 may be normalised so that it may be used during the training procedure as described below with reference to FIG. 7.

Linear interpolation may be performed on pairs of all model parameter values from the first set of model parameters 326 and the second set of model parameters 328 to obtain corresponding model parameter values in the set of inference model parameter 322. The pairs of model parameter values from the first and second model parameter sets may correspond to identical elements in the neural network architecture (such as biases of the same node) associated with the machine learning model 218. In some examples, the linear interpolations for each pair of model parameters may be combined into a single high-dimensional linear interpolation that can be used to determine all model parameters for corresponding values of the input data parameters. Consequently, the corresponding model parameter WIN in the set of inference model parameters 322 may also correspond to the same element (bias for the same node) in the neural network architecture associated with the machine learning model 102. The resulting set of inference model parameters 322 may be used for processing image data 316 to generate output data 324 corresponding to the parameter value P_{IN}.

Linear interpolation may be extended to cases where the machine learning model 102 comprises more than two sets of model parameters. In such cases, piecewise linear interpolation may be conducted between pairs of model parameters sets whose respective reference parameter values are adjacent to each other. For example, a set of intermediate model parameters 330 may be included in the machine learning model 102. The set of intermediate model parameters 330 may be associated with a corresponding intermediate reference value of the input data parameter that may lie between the first and second reference values of the input data parameter. Depending on the parameter value associated with the image data 316, linear interpolation may either be performed between the first and the intermediate sets of model parameters or the intermediate and the second sets of model parameters. The strategy described may be extended to cases with higher numbers of model parameter sets. In such cases, a sequence of linear interpolations may be employed over the full range of reference parameter values.

By increasing the number of model parameter sets included in the machine learning model 102, the accuracy of the overall interpolation may be increased while maintaining a linear order of interpolation. In some cases, a non-uniform variation with parameter values may be expected for the mapping between input data 316 and output data 324. In such cases, the sets of model parameters may not be uniformly distributed with respect to their respective reference parameter values. Such strategies may be useful in addressing different parametric variations of the input data whilst retaining a linear order of interpolation.

FIG. 4B shows an illustrative example of non-linear interpolation. In this example also, the multiple sets of model parameters in the machine learning model 318 comprises an intermediate set of model parameters 330 associated with an intermediate reference value P_{X} of the input data parameter. For example, FIG. 4B shows a weight value W_{X} for the node determined between weight values W₁ and W₂ in the first and second sets of model parameters respectively. The weight value W_{X} and the parameter value P_{X} designate the point (P_{X},W_{X}) on the weight-parameter plane. A non-linear function 434 such as the polynomial w=a₀+a₁p+a₂p² may be interpolated through the three points, (P₁,W₁), (P_{X},W_{X}), and (P₂,W₂). By substituting each of the known points, the coefficients a₀, a₁, and a₂ may be determined. In other implementations, a Lagrange polynomial may be used. A normalised representation of the non-linear function may be determined by normalising the coefficients to support the training procedure as described below with reference to FIG. 7.

In the example shown in FIG. 4B, the points apparently lie on a curve which is determined by a quadratic equation as shown above. In some cases, higher-order interpolation may be desirable: generally, polynomials of arbitrarily high order may be interpolated so long as an adequate number of model parameter sets are included in the machine learning model 102. In still other cases, a polynomial representation may not satisfactorily represent the parametric variation of model parameters even at high orders. In such cases, non-linear interpolation may be performed using transcendental functions such as the exponential function and/or a square wave and/or a sawtooth function. It may, however, be necessary in such cases to further increase the number of sets of model parameters included in the machine learning model 102 to fully determine the non-linear interpolation function 434.

In general, non-linear interpolation can be extended to functions of arbitrary complexity that may be determined using the multiple sets of model parameters included in the machine learning model 102. Once determined, the non-linear function 434 can be used to determine an interpolated value of the model parameter W_{IN} based on the model parameter W₁, the reference parameter value P₁, the model parameter value W_{X}, the reference parameter value P_{X}, the model parameter value W₂, and the reference value P₂. As with linear interpolation described with reference to FIG. 4A, the non-linear interpolation strategy may be performed sequentially for all tuples of model parameters in the sets of model parameters included in the machine learning model 102. The model parameters included in each tuple of values may comprise values of weight or a bias corresponding to the same edge or node in the neural network architecture associated with the machine learning model 102. In this manner, a set of inference model parameters 322 may be determined by the configuration module 320 by performing non-linear interpolation over the multiple sets of model parameters included in the machine learning model 102.

Within a given range of reference parameter values, non-linear interpolation may represent the parametric variation of the model parameters more accurately and may therefore be preferable to linear interpolation for certain applications. In some use cases, a mixture of linear and non-linear interpolation strategies may be used to configure the machine learning model 102 for media processing. For example, linear interpolation may be performed within a given range of reference parameter values and non-linear interpolation may be performed within a remaining range of reference parameter values. As an example, the model parameter values may vary non-linearly in a range 90<gain<100, whereas the model parameter values may vary linearly in the range 0<gain<90. In such cases, non-linear interpolation may be adopted for a narrow window of gains using a higher number of sets of model parameters within that range of reference parameter values, while a limited number of sets of model parameters may be required in the remaining range of reference parameter values. The combination of linear and non-linear interpolation functions may allow the machine learning model 102 to be configured to parametric variations of arbitrary complexity. In this manner, processing of image data 316 may be extended to arbitrary settings such that the corresponding output data 324 closely conforms with the parameter value associated with the input data over a wide range of reference values.

Applicability to a wide range of parametric settings may thereby enable the machine learning model 102 to be emulated in dedicated hardware in the information processing apparatus 200 without the need for routine tuning or re-configuration for novel parametric settings. As a result, the information processing apparatus 200 may be resilient to a wide range of parametric variability settings and have a broader scope of use.

The examples above use a single parameter value. In some implementations, the parameter data 314 may include a number of secondary parameters that are combined using mathematical operations to obtain a single parameter value associated with the input data parameter. As an example, the image data 316 may have an associated first input data parameter (for example gain at the time of image capture) and second input data parameter (for example temperature at the time of image capture), and determining the parameter value may comprise combining the first input data parameter and the second input data parameter. For example, the first input data parameter and second input data parameter may be combined by weighted addition.

The information processing apparatus 100 may be configured to process image data 316 associated with more than one input data parameter determined using the parameter data 314. In such cases, the input data parameter may be a first input data parameter and the parameter value may be a first parameter value. The image data 316 may additionally be associated with a second input data parameter associated with a second parameter value. For example, illuminance may be a second parameter in addition to the first parameter designating a gain.

Whether to use one or more than one parameter will depend upon the operation that the machine learning model 102 is expected to perform. The identification of image data 316 with two or more parameters may not necessarily mean that a parametric variation of the machine learning model 102 over each of the parameters is required. For example, though the image data 316 may require a parameter-dependent processing (for example to remove noise) for one such parameter (such as gain), but may not exhibit any parameter sensitive variations for another parameter (such as date of image capture or file size). In such cases, previous strategies of interpolation over a single parameter may suffice. However, in many cases, image data 316 may reflect variations relevant to the processing being performed with two or more parameters and thereby a multi-variable interpolation based on different input data parameters may be desirable.

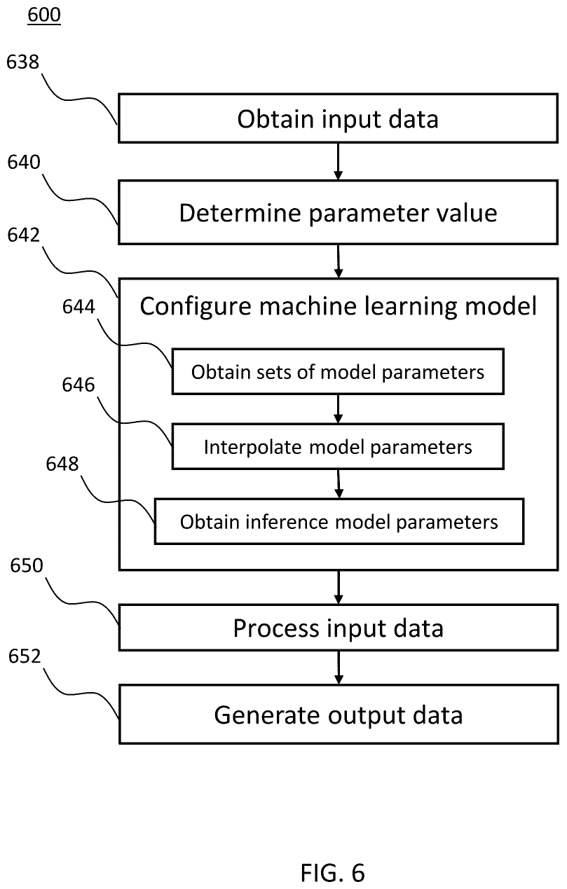

Consider the case where a first and a second parameter are associated with the image data 316. FIG. 5 shows an illustrative example of bilinear interpolation over the first parameter and the second parameter. In addition to the first and second sets of model parameters, the machine learning model 102 may include a third set of model parameters and a fourth set of model parameters (not visualised in FIG. 3). The first set of model parameters 326, second set of model parameters 328, third set of model parameters, and fourth set of model parameters may each be associated with respective values of the first input data parameter and the second input data parameter.

FIG. 5 shows weight values W₁, W₂, W₃, and W₄ associated with a single weight positioned on an edge of the neural network architecture. The weight values W₁, W₂, W₃, and W₄ correspond to values of the same weight position in each of the first, second, third and fourth sets of model parameters. Each weight value is associated with a pair of reference values corresponding to the values of the first and second parameters for the given set of model parameters. For example, the points (P₁,P₁) and (P₂,P₁) represent the pairs of reference values for the first and second sets of model parameters. The pairs of reference values are associated with two different values P₁ and P₂ for the first parameter, and a given value P₁ for the second parameter. Likewise, the points (P₁,P₂) and (P₂,P₂) represent the pairs of reference values for the third and fourth sets of model parameters. Here, the pairs of reference values are associated with two different values of the first parameter for a given second value P₂ of the second parameter.

One approach to bilinear interpolation involves determining a function 536, such as w=a₀₀+a₁₁p₁+a₂₂p₂+a₁₂p₁p₂ where w is the weight value associated with the values p₁ and p₂ of the first and second input data parameters, which is linear in each of the input data parameters. The coefficients a₀₀, a₁₁, a₂₂, and a₁₂ may be obtained, for example, by solving an appropriate matrix equation formed by inserting the values of weights W₁, W₂, W₃, and W₄ corresponding to each of the parameter points in FIG. 5. An alternative approach to bilinear interpolation may involve repeated linear interpolation over different parameter values.

In general, a range of bilinear interpolation techniques may be adopted either from standalone computational libraries that can be preinstalled in the configuration module 220. Once determined, the bilinear interpolation function 536 may be used to determine the weight value W_{IN} corresponding to the combination of first and second parameter values (P_{IN}, P_{IN}) associated with the input data 216. The bilinear interpolation technique may be extended to all model parameters in each of the first, second, third and fourth sets of model parameters. In this manner, a set of inference model parameters 322 may be determined using bilinear interpolation over the multiple sets of model parameters included in the machine learning model 102. The resulting set of inference model parameters 322 may be used to process the input data 216 and obtained output data 224 associated with the combination of first and second parameter values (P_{IN}, P_{IN}).

As discussed in the context of linear interpolation, multi-parameter interpolation can involve non-linear or piecewise linear interpolation techniques. For example, biquadratic interpolation may be performed using at least three sets of model parameters for each of the first and second set of input data parameters. Likewise, a mixture of linear and non-linear interpolation techniques may be employed. For example, a non-linear interpolation function may be piecewise bilinear over a given range of reference parameter values associated with the first and second input data parameter. Over a remaining range of reference values, the interpolation function may be non-linear, such as in the case of biquadratic, bicubic, etc interpolation. Moreover, the interpolation techniques discussed may be extended to cases with more than two input data parameters. In general, an arbitrary number of input data parameters may be used as the basis for interpolation and an arbitrary number of sets of model parameters may be included in the machine learning model 102 to achieve an arbitrarily high order of interpolation.

In this manner, a wide range of settings with diverse parametric variabilities may be addressed for media processing by the information processing apparatus. As the complexity of the machine learning model increases, the memory requirements for storing the sets of model parameters may increase also. A further example is discussed below in which a second machine learning model is included to replace the interpolation function.

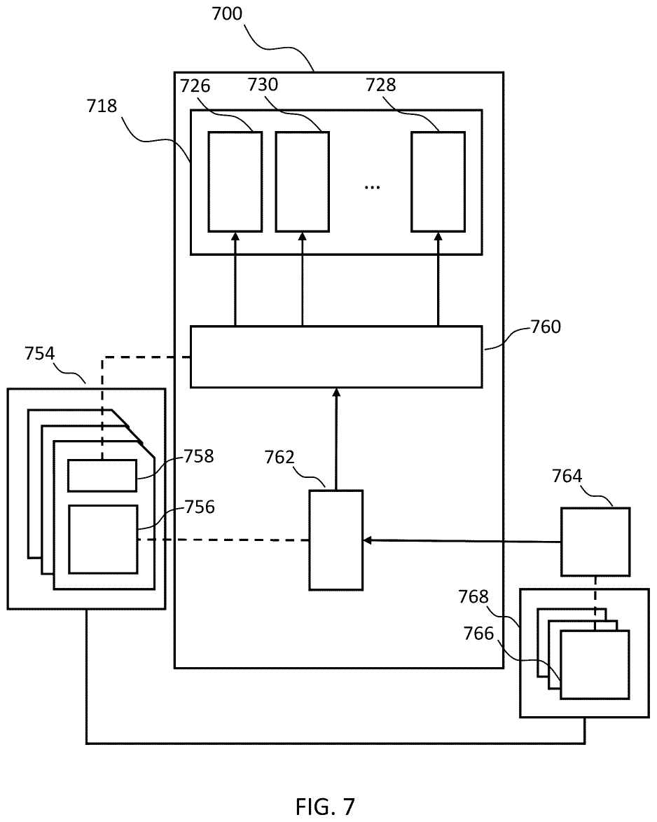

FIG. 6 shows a flow diagram of the method performed by the information processing apparatus 100 for media processing.

At step 638, the information processing apparatus 200 obtains input data 316.

At step 640, determines one or parameter values for one or more parameters using parameter data 314 associated with the input data 312.

At step 642, the method proceeds by configuring a machine learning model 102 included in the information processing apparatus 200. Configuring the machine learning model may involve a series of steps in which an interpolation is performed to obtain a set of inference model parameters. For example, at step 644, multiple sets of model parameters included in the machine learning model may be obtained, each set of model parameter may be associated with a reference value or values of the multiple input data parameters associated with the input data 316. At step 646, the sets of model parameters may be interpolated to obtain a set of inference model parameters 322 at step S648.

At step 650, the input data 312 may be processed using the set of inference model parameters 322 thereby generating, in step 652, output data 324 associated with the parameter values of the input data parameters associated with the input data 312.

While the implementation above, has been described using image data as an example, in other embodiments the data 316 may include or consist of audio or graphical content: for example, the input data 216 may be an image or a video or an audio recording. In other applications, the data may not be media data and could include any other type of data, such as, for example, network traffic data, financial data, vehicle traffic data, website metadata, etc. The processing performed by the machine learning model has been described in connection with removing noise from an image. However, other processes such as identification of people or objects, image processing such as sharpening, colour adjustment, etc. or other processing such as unusual network traffic detection, vehicle route planning, etc. could be performed. Further, the parameter data may include any parameters that are relevant to the processing being performed, which will vary depending on the context.

### Training of Machine Learning Model

FIG. 7 illustrates a method performed for training a machine learning model 718 included in the information processing apparatus 700. The trained machine learning model may be the machine learning model 102 described above and used for inference as previously described. In particular, FIG. 7 shows steps performed during a backpropagation stage as described further below.

In general, training the machine learning model may comprise obtaining a set 754 of training data. For example, the training data may comprise a number of media files each associated with sample data 756. As discussed hereinbefore in the context of media processing, the sample data 756 may be an image or an audio or video file. Further, the sample data 756 may be associated with sample parameter data 758 that includes a parameter value of a sample parameter associated with the sample data 756.

In some examples, the sample parameter may be a gain or noise characterising the image associated with the sample data 756. As discussed previously, the parameter data may be included in metadata associated with files containing sample data 756. Moreover, the machine learning model 718 may comprise multiple sets of model parameters including a first set of training model parameters 726 associated with a first reference value of an input data parameter and a second set of training model parameters 728 associated with a second reference value of the sample parameter.

At an initial stage of training, the first and second sets of training model parameters 726 and 728 may be assigned random values. Alternatively, the sets of training model parameters may be obtained from a pre-trained machine learning model and further tuned over the training process. The first and second sets of model parameters 726 and 728 may each be assigned a respective reference parameter value (or where there are multiple parameters, a reference parameter value for each parameter). These parameter values may not be selected at random and may be selected to represent extremities of ranges (e.g. a maximum and minimum gain) or desired intermediate values. For example, the first reference value may correspond to a gain value of 0% and a second reference value may correspond to a gain value of 100%.

The training method may include carrying out one or more iterations. Each iteration may include a forward pass stage (not visualised in FIG. 7) and a backpropagation stage. During a forward pass stage, each iteration may include selecting from the set of training data 754, sample data 756 associated with a sample parameter value determined using the sample parameter data 758. The iteration may proceed by configuring the machine learning model 718 using a configuration module (not shown in FIG. 7) to determine a set of sample model parameters 762 associated with the sample parameter value. For example, the first set of training model parameters 726 and the second set of training model parameters 728 may be interpolated to determine a set of sample model parameters 762.

Interpolating the two sets of training model parameters may adopt one of the interpolation techniques described previously. For example, interpolating the training model parameters 728 may involve determining an interpolation function based on the first set of training model parameters 726, the first reference value, the second set of training model parameters 728, and the second reference value. The interpolation function may, for example, be a linear polynomial whose coefficients are determined using the model parameter values and the corresponding reference values. In some examples, a linear interpolation function may be determined in a manner similar to the technique described with reference to FIG. 4A. The coefficients of the interpolation function so determined may be normalised for use during the subsequent backpropagation stage. The set of sample model parameters 762 may be determined by evaluating the interpolation function for the sample parameter value.

Having determined the set of sample model parameters 762, the forward pass stage of each iteration may proceed by processing the sample data 756 using the sample model parameters 762 to obtain sample output 764. A cost may be estimated in relation to the sample output 764. For example, in supervised learning, a ground truth output 766 associated with the sample data 756 may be provided as part of a set of sample outputs 768 in advance. In such cases, the cost may be estimated based on a cost function comparing the sample output 764 and the ground truth output 766. In other machine learning approaches, such as reinforcement or unsupervised learning, the cost may be estimated as a function of the sample output 764 without employing the ground truth output 766. Regardless of the approach taken, the forward pass of the training method may lead to the estimation of a cost associated with the sample output 764.

FIG. 7 shows that the training iteration proceeds to use the estimate cost to update the first set of model parameters 726 and the second set of model parameters 728. In the example shown, the method employs a backpropagation method to perform the necessary updates. In particular, FIG. 7 shows that the backpropagation stage may involve using the estimated cost associated with the sample output 764 to first update the set of sample model parameters 762. This may be achieved by backpropagating the estimated cost through the layers of the neural network associated with the set of sample model parameters 762. Backpropagating the cost may result in determining an adjustment associated with each of model parameters in the set of sample model parameters 762. The adjustment may be applied to the respective model parameters 762 to update the set of sample model parameters 762.

FIG. 7 shows a distribution module 760 that may be used to distribute the cost further between the first set of training model parameters 726 and the second set of training model parameters 728. For example, the distribution module 760 may employ the interpolation function determined during the forward pass of the iteration to calculate updates for the first and second sets of training model parameters. In particular, having determined an adjustment to the set of sample model parameters 762, the interpolation function may be used to determine a corresponding update to the first set of training model parameter values 726 and the second set of training model parameters 728.

In one example, the loss is distributed according to interpolation coefficients. If a first set of model parameters used earlier in interpolation to generate the sample parameter values is associated with parameter value P₁ and a second set of model parameters used earlier in interpolation is associated with parameter value P₂, the parameter value of the sample, P_{S} is normalized by (P_{S}−P₁)/(P₂−P₁). The interpolation coefficient that distributes adjustment for a model parameter value to the corresponding model parameter value in a set of model parameters associated with W₂ is given by the normalized value of P_{S}. The remainder of the loss is distributed to the corresponding model parameter value in the set of model parameters associated with W₁. It can be seen that when a sample parameter value, P_{S}, falls on P₁, none of the loss is attributed to the set of model parameters associated with P₂. Conversely when P_{S} falls on P₂, all of the loss is attributed to the second set of model parameters associated with P₂ and none is attributed to the first set of model parameters associated with P₁. The loss distribution associated with the interpolation coefficients varies linearly as the parameter value of the sample, P_{S}, varies between P₁ and P₂. In this manner, the estimated cost may be effectively backpropagated to the sets of training model parameters included in the machine learning model 718.

Another approach that works for a single parameter is to determine the contributions based on the sample weight value determined by the interpolation equation, W, the weight value, W₁, associated with the first set of weight parameters and the weight value, W₂, associated with the second set of weight parameters. The interpolation coefficient, α, that distributes adjustments to the second set of model parameters can be determined according to W=α*W₂+(1−α)*W₁. This approach works for both linear and non-linear interpolation equations.

The updated sets of training model parameters may thereby be used as the starting point for a subsequent training iteration. As a result, the machine learning model 718 may be trained over a series of iterations until a satisfactory condition is attained. For example, the machine learning model 718 may over the course of training learn to accurately generate sample outputs 764 associated with relatively low associated costs. A stopping condition may thereafter be satisfied based on a threshold value of the cost associated with sample output. In other examples, training may be terminated after a fixed number of iterations. The trained machine learning model 718 may subsequently be used in the information processing apparatus 100.

In the training method described, the estimated cost in each iteration is dependent on the accuracy of the sample output 764 generated by applying the set of sample model parameters 762. This is dependent on the accuracy with which the set of sample model parameters 762 are interpolated from the first and second set of training model parameters 726 and 728 in the first place. Since the cost in each iteration is backpropagated to the sets of training model parameters, the sets are trained over the iterations to more accurately interpolate to the set of sample model parameters 762. Thus, the machine learning model 718 is trained to be configurable to the sample parameter value via interpolation of the sets of training model parameters. In the absence of such a training method, applying interpolated sets of model parameters to input data may generate nonsensical data, even if each of the sets of model parameters may individually generate sensical outputs from the input data. The training method described therefore overcomes an obstacle in the art of machine learning

To improve the performance of training described so far, the set of training data 754 may include a selection of sample inputs associated with sample parameter values spanning a range of values in the interval separating the first and second reference values. In some cases, the sample parameter values associated with sample inputs may be uniformly distributed over the interval. In other cases, the set of training data 754 may only include sample inputs associated with parameter values lying in a portion of the interval. Training based on this set of training data 754 may lead to a bias in the trained machine learning model 718, which may thereby inaccurately represent the parametric variation of model parameters in the remaining portion of the interval. In order to mitigate the bias, the training method may additionally include a regularisation cost in the cost associated with each sample output 764. By using a regularisation cost, the sets of training model parameters may be trained to determine interpolation functions that are regularised in the entire interval of reference values. Consequently, the configured machine learning model 718 may generate output data more accurately during the inference stage over the entire range of parameter values.

Furthermore, the machine learning model 718 may contain multiple sets of training model parameters 726, 730, and 728. In particular, FIG. 7 shows that the machine learning model 718 includes an intermediate set of training model parameters 730 associated with an intermediate reference value of the sample parameter. The intermediate reference value may, for example, lie between the first and second reference values associated with the first and second set of training model parameters. Using the intermediate set of training model parameters 730, piecewise linear (as described with reference to FIG. 4A) or non-linear interpolation (as described with reference to FIG. 4B) may be performed. Using more than two sets of training model parameters may allow the accuracy of interpolation may be increased.

The set of sample model parameters 762 associated with the sample parameter value may be determined by interpolating the intermediate set of training model parameters 730 during the forward pass. For example, piecewise linear interpolation may be performed over the first set of training model parameters 726 and the intermediate set of training model parameters 730 on the one hand, and the second set 728 parameters and the intermediate set 730 on the other hand. Depending on the placement of the sample parameter value with respect to the first, second and intermediate reference values, the appropriate linear interpolation function may be used to determine the set of sample model parameters 762. In other examples, the intermediate set of training model parameters 730 may be used together with the first and second sets of training model parameters 726 and 728 to determine a non-linear interpolation function. As described with reference to FIG. 4B, a non-linear function such as a quadratic polynomial may be determined.

Having determined the interpolation function, a sample output 764 may be calculated using the set of sample model parameters 762. Subsequently, during the backpropagation stage, the sets of training model parameters including the intermediate set of training model parameters 730 may be updated by backpropagating the cost associated with the sample output 764. To this end, the interpolation function employed during the forward pass may be used to distribute an adjustment for the set of sample model parameters 762 to the sets of training model parameters 726, 728 and 730.

In this manner, the multiple sets of training model parameters 726, 728 and 730 may be updated during each training iteration. In general, the machine learning model 718 may include an arbitrarily large number of sets of training model parameters that are used to perform an arbitrarily high order of interpolation.

The training method may also be extended to multi-parameter settings. For example, the sample data 756 may be associated with a second sample parameter value for a second input data parameter in addition to the first sample parameter value for the input data parameter. In some cases, two (or more) parameter values may be combined to obtain a single parameter associated with the sample data 756. Each set of training model parameters included in the machine learning model 718 may correspond with reference values for the combined parameter.

In other cases, the machine learning model 718 may include multiple sets of training model parameters associated with reference values for the first and second sample parameters. For example, the multiple sets of model parameters may further include a third set of model parameters and a fourth set of model parameters (not shown in FIG. 7). The first set of model parameters, second set of model parameters, third set of model parameters and fourth set of model parameters may each be associated with respective reference values of the first input data parameter and the second input data parameter. Each training iteration may then comprise interpolating model parameter values from the third set of model parameters and the fourth set of model parameters to determine the set of sample model parameters 762. The interpolated set of sample model parameters 762 may then be used to obtain sample outputs 764, and an estimated cost associated with the sample output 764 may be backpropagated to the first, second, third and fourth sets of training model parameters.

In order to train multiple sets of training model parameters, approaches similar to those discussed with reference to FIG. 5 may be adopted. During the forward pass, the first, second, third and fourth sets of training model parameters may each be interpolated based on an interpolation function. In some examples, bilinear interpolation may be performed using a planar interpolation function as described previously. The coefficients of the interpolation function may be determined using the sets of training model parameters and the associated reference values. An interpolation function determined in this manner may be used to obtain a set of sample model parameters 762 associated with the sample parameter value. During a backward pass, the cost associated with a sample output 764 may be backpropagated to determine an adjustment for the set of sample model parameters 762. The coefficients of the interpolation function may then be determined to estimate corresponding updates for the first, second, third and fourth sets of training model parameters. In one example, the loss may be distributed according to a normalized distance between the position of the sample in parameter space defined by the plurality of parameter values and the positions of parameter values associated with the first, second, third and fourth sets of training model parameters. The multiple sets of training model parameters may be updated during each iteration in this manner.

In further examples, the training method may be applied to scenarios with three or more sample parameters. In such examples, the machine learning model 718 may include additional sets of training model parameters to capture the parametric variation with the additional parameters. and the multiple sets of training model parameters may be updated in dependence on the estimated cost during the backpropagation stage.

FIG. 8 shows a flow diagram of the method performed for training the machine learning model included in the information processing apparatus.

In step 870, the training method begins by obtaining a set of training data comprising sample data 756 with associated parameter data 758.

In step 872, one or more parameter values may be determined from the parameter data 758. Subsequently in steps 874 to 886 one or more training iterations may be performed, each including a forward pass and a backward pass stage.

At step 874, sample data 756 may be selected from the set of training data 754.

As part of the forward pass, in step 876, sample model parameters 762 may be initially determined by, for example, configuring the machine learning model 718 to the sample parameter values from a distribution. A configuration module (not shown in FIG. 7) may be used to configure the machine learning model 718 to the sample parameter values. As discussed previously, the configuring step may involve interpolating model parameter values from multiple sets of training model parameters.

The set of sample model parameters 762 determined may be used, in step 878, to generate a sample output 764.

A cost associated with the sample output may be estimated in step 880. Estimating the cost may further involve determining a regularisation cost and any additional cost terms. Backpropagation stage may begin once the cost has been estimated.

In step 882, the backpropagation may comprise updating the sample model parameters 762 in dependence on the cost. In particular, an adjustment for the sample model parameters 762 may be computed as a result of backpropagating through the layers of the associated neural network architecture.

In step 884, the adjustment determined for the sample model parameters 762 may be transferred in dependence on a set of interpolation coefficients to the multiple sets of training model parameters. The coefficients may be determined in dependence on an interpolation function used for interpolating the multiple sets of training model parameters during the forward pass, based on a distance of the sample parameter value from the parameter values of the multiple sets of training model parameters, or otherwise.

Training iterations comprising steps 874 to 884 may be repeated until a stopping condition is satisfied. In step 886, the stopping condition is checked. If the stopping condition is satisfied, the multiple sets of training model parameters may be considered to be trained. If it isn't, the iterations may continue. In this manner, the machine learning model 102 employed by the information processing apparatus may be trained.

### Inference Using a Machine Learning Model—Second Machine Learning Model

As mentioned above, an inference model may perform a process that depends upon more than one input data parameter. As the number of input data parameters increases, the number of sets of model parameters required to determine the inference model parameters will increase rapidly if a set of model parameters is provided at each limit value enclosing a multidimensional parameter space formed from the input data parameters. Accordingly, in some implementations, a second machine learning model may be employed.

Rather than performing interpolation between sets of model parameters, in these examples, the second machine learning model may be trained to generate a set of inference model parameters based on input of a set of input data parameter values.

During the training described above, each model parameter value has an associated adjustment that is the difference between the parameters of the inference model generated by the second machine learning model and the parameters of the inference model after back propagation. The second machine learning model may receive this adjustment as a cost function for the generated set of inference model parameters and may perform a further step of back propagation to update its model parameters. In this way, as the machine learning model 102 is trained, the second machine learning model may be trained in parallel to generate model parameters based on a set of input parameters.

After training and during inference, the second machine learning model determines a set of inference model parameters 322 directly from the parameter values corresponding to a set of input data parameters 314 associated with the input data 316. The inference model parameters 322 may then be applied directly to the input data 316 to perform the desired processing.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method performed by an information processing apparatus comprising:
obtaining input data;
determining a parameter value of an input data parameter associated with the input data;
configuring a machine learning model to the parameter value; and
processing the input data using the configured machine learning model to generate output data associated with the parameter value,
wherein configuring the machine learning model comprises determining a set of inference model parameters associated with the determined parameter value by performing either of:
(i) interpolating model parameter values from two or more sets of model parameters to obtain the set of inference model parameters, each set of the two or more sets of model parameters being associated with a respective reference value of the input data parameter, or
(ii) applying a second machine learning model to the parameter value to obtain the inference model parameters, and
wherein processing the input data using the configured machine learning model comprises applying the inference model parameters to the input data.

2. The method of claim 1, wherein the machine learning model comprises multiple sets of model parameters including a first set of model parameters associated with a first reference value of the input data parameter and a second set of model parameters associated with a second reference value of the input data parameter, and
wherein the set of inference model parameters are determined by interpolating model parameter values from the first set of model parameters and the second set of model parameters.

3. The method of claim 2, wherein interpolating the first set of model parameters and the second set of model parameters comprises determining interpolation functions based on the first set of model parameters, the first reference value, the second set of model parameters, and the second reference value,
and wherein the set of inference model parameters is determined by evaluating the interpolation functions at the determined parameter value.

4. The method of claim 2, wherein the multiple sets of model parameters include an intermediate set of model parameters associated with an intermediate reference value of the input data parameter, the intermediate reference value lying between the first reference value and the second reference value of the input data parameter,
and wherein determining the set of inference model parameters comprises interpolating model parameter values from the intermediate set of model parameters to determine the set of interpolated weights associated with the determined parameter value.

5. The method of claim 1, wherein the input data has an associated first input data parameter and second input data parameter, and wherein determining the parameter value comprises combining the first input data parameter and the second input data parameter.

6. The method of claim 1, wherein the input data parameter is a first input data parameter and the parameter value is a first parameter value, the method further comprising determining a second parameter value for a second input data parameter associated with the input data.

7. The method of claim 2, wherein the input data parameter is a first input data parameter and the parameter value is a first parameter value, the method further comprising determining a second parameter value for a second input data parameter associated with the input data, and wherein:
the multiple sets of model parameters further include a third set of model parameters and a fourth set of model parameters,
the first set of model parameters, second set of model parameters, third set of model parameters, and fourth set of model parameters each being associated with respective values of the first input data parameter and the second input data parameter, and
configuring the machine learning model further comprises interpolating model parameters values from the third set of model parameters and the fourth set of model parameters to determine the set of interpolated model parameters.

8. The method of claim 1, comprising:
obtaining, by the information processing apparatus, metadata associated with the input data, the parameter value being determined in dependence on the metadata.

9. The method of claim 8, wherein the input data is an image and the metadata designates a measurable characteristic of the image, the conditions in which the image was captured, or device settings used to capture the image.

10. The method of claim 9, wherein the input data parameter designates a noise level associated with a sensor measurement or with a gain.

11. A computer-implemented method for training a machine learning model, the machine learning model comprising multiple sets of model parameters including a first set of training model parameters associated with a first reference value of an input data parameter and a second set of training model parameters associated with a second reference value of the input data parameter, the method comprising:
obtaining a set of training data; and
carrying out one or more iterations comprising:
selecting, from the set of training data, sample data associated with a sample parameter value;
determining a set of sample model parameters associated with the sample parameter value by interpolating model parameter values from the first set of training model parameters and the second set of training model parameters;
estimating a cost in dependence on sample outputs generated by applying the set of sample model parameters to the sample data; and
updating the multiple sets of model parameters in dependence on the estimated cost.

12. The method of claim 11, wherein interpolating the first set of training model parameters and the second set of training model parameters comprises determining an interpolation function for each model parameter based on the corresponding model parameter in the first set of training model parameters, the first reference value, the corresponding model parameter in the second set of training model parameters, and the second reference value,
and wherein the sample model parameter is determined by evaluating the interpolation function at the sample parameter value.

13. The method of claim 12, further comprising calculating one or more interpolation coefficients that distribute the cost between the first set of training model parameters and second set of training model parameters, wherein updating the multiple sets of training model parameters comprises:
estimating an adjustment for the sample model parameters in dependence on the cost; and
updating the first set of training model parameters and the second set of training model parameters in dependence on the adjustment and the one or more interpolation coefficients.

14. The method of claim 11, wherein the multiple sets of model parameters include an intermediate set of training model parameters associated with an intermediate reference value of the parameter, the intermediate reference value lying between the first reference value and the second reference value of the input data parameter,
and wherein determining the set of sample model parameters associated with the sample parameter value comprises interpolating model parameter values from the intermediate set of model parameters.

15. The method of claim 14, wherein:
interpolating the intermediate set of model parameters comprises determining interpolation functions based on the intermediate set of model parameters and the intermediate reference value, and
updating the multiple sets of model parameters comprises updating the intermediate set of model parameters in dependence on the adjustment and one or more interpolation coefficients.

16. The method of claim 11, wherein:
the sample data is associated with a second sample parameter value for a second input data parameter,
the multiple sets of model parameters further include a third set of model parameters and a fourth set of model parameters,
the first set of model parameters, second set of model parameters, third set of model parameters and fourth set of model parameters each having respective values of the first input data parameter and the second input data parameter, and
the one or more training iterations comprises:
interpolating model parameter values from the third set of model parameters and the fourth set of model parameters to determine the set of sample model parameters; and
updating the multiple sets of model parameters comprising updating the third set of model parameters and the fourth set of model parameters in dependence on the adjustment for the set of sample model parameters and interpolation coefficients for each of the first set of model parameters, second set of model parameters, third set of model parameters and fourth set of model parameters.

17. A method performed by a computer processor connected to an input data device, the method comprising:
obtaining input image data from the input data device;
determining a parameter value of an input data parameter associated with the input image data;
configuring a machine learning model to the parameter value; and
processing the input image data using the configured machine learning model to generate output image data associated with the parameter value,
wherein configuring the machine learning model comprises determining a set of inference model parameters associated with the determined parameter value by performing either of:
(i) interpolating model parameter values from two or more sets of model parameters to obtain the set of inference model parameters, each set of the two or more sets of model parameters being associated with a respective reference value of the input data parameter, or
(ii) applying a second machine learning model to the parameter value to obtain the inference model parameters, and
wherein processing the input image data using the configured machine learning model comprises applying the inference model parameters to the input image data.

18. The method of claim 17, wherein processing the input image data using the configured machine learning model involves removing noise from the input image data.

19. A data processing system comprising means for carrying out the method of claim 1.

20. A computer program product comprising instructions which, when the program is executed by a computer, cause the computer to carry out the method of claim 1.
